(19) United States
(12) Patent Application Publication
(10) Pub. No.: US 2003/0136501 A1
(43) Pub. Date: Jul. 24, 2003

(54) Method for preparing resin-coated sheet

(76) Inventor: Kazue Watanabe, Tokyo (JP)

Correspondence Address: Jordan and Hamburg, 122 East 42nd Street, New York, NY, 10168, US

(21) Appl. No.: 10/049,780

(22) PCT Filed: May 11, 2001
(86) PCT No.: PCT/JP01/02960

(30) Foreign Application Priority Data
May 11, 2000 (JP) 2000-180539

(51) Int. Cl. B32B 31/00

(52) U.S. Cl. 156/247; 156/280

(57) ABSTRACT

After an aqueous emulsion of a non-tacky or weakly tacky acrylic copolymer 4 has been infiltrate into a moisture-permeable sheet material 2 throughout almost the entire range in its thickness direction, the sheet material is dried while keeping one side of the sheet material in close contact with a non-moisture-absorptive protection sheet 3 having a smooth surface. Then a transparent coating film 8 having a smooth surface and consisting of the dried non-tacky or weakly tacky acrylic copolymer 4 is formed on the one side of the sheet material by stripping the protection sheet from the one side of the sheet material.

### TECHNICAL FIELD

The present invention relates to a method for manufacturing a resin-coated sheet and, more particularly, to a method for manufacturing a resin-coated sheet having a transparent resinous film having a smooth surface, and to a method for manufacturing a tacky resin-coated sheet.

### BACKGROUND ART

There has been known a seal etc. which has on its back side a tacky layer and is strippable and reusable many times. However, a large-scale production equipment or special-purpose machines were needed to manufacture it. Further, several methods have been known about how to carry out coating of a surface of sheet material which consists of cloth, paper or the like by the transparent resin film, but all needed a large-scale production equipment or the apparatus of exclusive use. Further, since a tacky layer or a transparent resinous film prepared on a surface of a sheet material is easily inseparable from the sheet material, there has been a problem that classifying and discarding according to material is impossible.

Therefore, a first object of the present invention is to provide a method for easily and cheaply manufacturing a resin-coated sheet which has a transparent resinous film having a smooth surface, and which can be easily classified and discarded according to material.

Further, a second object of the present invention is to provide a method for easily and cheaply manufacturing a tacky resin-coated sheet which is strippable for any number of uses and which can be easily classified and discarded according to material.

### DISCLOSURE OF THE INVENTION

In order to achieve the above-mentioned first object, the present invention provides a method for manufacturing a resin-coated sheet, comprising the steps of: infiltrating an aqueous emulsion of a non-tacky or weakly tacky acrylic copolymer having water as a main evaporation ingredient into a moisture-permeable sheet material throughout almost the entire range in its thickness direction; placing a non-moisture-absorptive protection sheet which has a smooth surface on and in close contact with one side of the resultant sheet material and then drying the sheet material; and forming a transparent coating film which has a smooth surface and comprises a dried non-tacky or weakly tacky acrylic copolymer, on one side of the sheet material by stripping the protection sheet from the sheet material.

According to the above-mentioned method, it is possible to manufacture a resin-coated sheet which has at one side thereof a transparent dry coating film of an acrylic copolymer having a smooth surface, without needing a large-scale production equipment. Further, since the transparent coating film having a smooth surface is formed by drying a non-tacky or weakly tacky acrylic copolymer which has infiltrated into the sheet material, it is strongly joined to the sheet material and there is no fear of peeling off carelessly from the sheet material. Moreover, although a dried transparent coating film of an acrylic copolymer having a smooth surface demonstrates good waterproofness to the sheet material, the acrylic copolymer can be easily separated from the sheet material by soaking the resin-coated sheet in warm water etc., and agitating it. Therefore, it is possible to manufacture a resin-coated sheet which is easy to classify and discard according to material and is easy to reuse.

In the above-mentioned method, preferably, after the sheet material has dried, a strongly tacky coating film is formed on the other side of the sheet material, by applying an aqueous emulsion of a strongly tacky acrylic copolymer wholly or partially to the other side of the sheet material, and drying it. According to this constitution, an aqueous emulsion of a strongly tacky acrylic copolymer can join up strongly to the non-tacky or weakly tacky acrylic copolymer which has infiltrated into the sheet material and dry, and therefore, a strongly tacky coating film which is made by drying the strong tacky acrylic copolymer will not peel off carelessly from the sheet material. Accordingly, the back side of the resin-coated sheet which is covered with the transparent coating film of the acrylic copolymer having a smooth surface at one side can be stuck on various kinds of components via the strong tacky coating film, and it can be used repeatedly by stripping it. Moreover, since the transparent coating film in one side and the strongly tacky coating film in the other side are comprised of dry acrylic copolymers, it is possible to easily separate these acrylic copolymers from the sheet material by soaking the resin-coated sheet into warm water etc., and agitating it. Accordingly, it is possible to provide a resin-coated sheet which has a tacky back side and which is easy to classify and discard according to material and is easy to reuse.

In the above-mentioned method, preferably, a strongly tacky coating film is formed on a surface of the transparent coating film, by wholly or partially applying an aqueous emulsion of a strongly tacky acrylic copolymer to the surface of the transparent coating film which has been formed on the one side of the sheet material, and drying it. According to this constitution, since the strongly tacky coating film is formed on the surface of the transparent coating film which is formed on the one side of the sheet material, the surface of the transparent coating film formed on the one side of the sheet material can adhere to the glass surface etc. via the strongly tacky coating film. Furthermore, since the strongly tacky coating film consists of a dry strongly tacky acrylic copolymer, it can be transparentized by making thickness thin. Accordingly, when figures, characters, patterns, etc. are in the one side of the sheet material and the surface of the transparent coating film is stuck on a surface of a grass board, etc. via the strongly tacky coating film, the figures, characters, patterns, etc. of the sheet material can be seen through the transparent glass board, the strong tacky coating film, and the transparent coating film. Therefore, a tacky resin-coated sheet which is rich in ornament nature can be manufactured easily.

Further preferably, after the protection sheet has been stripped from the one side of the sheet material, an aqueous emulsion of a non-tacky or weakly tacky acrylic copolymer is infiltrated into the other side of the sheet material; the sheet material is then dried while a non-moisture-absorptive protection sheet having a smooth surface is kept in close contact with the other side of the sheet material; and a transparent coating film consisting of a dry non-tacky or weakly tacky acrylic copolymer and having a smooth surface is formed on the other side of the sheet material by stripping off the protection sheet from the other side of the sheet material. According to this constitution, a resin-coated sheet which has transparent coating films in the both sides of the sheet material and is excellent in the waterproofness can be manufactured easily and cheaply.

Further preferably, a strongly tacky coating film is formed on the surface of the transparent coating film of the other side of the sheet material, by applying an aqueous emulsion of a strongly tacky acrylic copolymer to the surface of the transparent coating film wholly or partially and drying it. According to this constitution, the resin-coated sheet excellent in the waterproofness which has the transparent coating film of an acrylic copolymer having the smooth surface on both sides of the sheet material, and has the tackyness by the strongly tacky coating film on the transparent coating film in one side or both sides can be manufactured easily and cheaply.

Further preferably, the aqueous emulsion of the non-tacky or weakly tacky acrylic copolymer is beforehand applied to the surface of the protection sheet, and the sheet material is thereafter stuck on the surface to infiltrate the aqueous emulsion into the sheet material. According to this constitution, since a proper quantity of an aqueous emulsion of the non-tacky or weakly tacky acrylic copolymer can be extended with a shape of film of mostly uniform thickness on the protection sheet, the aqueous emulsion of the non-tacky or weakly tacky acrylic copolymer can infiltrate to the sheet material easily, broadly and almost uniformly. In addition, work for making a transparent coating film of an acrylic copolymer having a smooth surface can be efficiently carried out by leaving the protection sheet until the non-tacky or weakly tacky acrylic copolymer dries.

Further, in order to achieve the above-mentioned second object, the present invention provides a method for manufacturing a resin-coated sheet, comprising the steps of: infiltrating an aqueous emulsion of a non-tacky or weakly tacky acrylic copolymer into a moisture-permeable sheet material throughout almost the entire range in its thickness direction; drying the sheet material; and forming a strongly tacky coating film on one side or both sides of the sheet material by applying an aqueous emulsion of a strongly tacky acrylic copolymer to one side or both sides of the aforementioned sheet material wholly or partially and drying it.

According to the above-mentioned method, since the strongly tacky coating film of the dry strongly tacky acrylic copolymer has tackyness in the state of dryness, one side or both sides of the resin-coated sheet can be stuck on the surface of various components, and it can use, stripping repeatedly. And after infiltrating an aqueous emulsion of a non-tacky or weakly tacky acrylic copolymer into the sheet material and making it dry, an aqueous emulsion of a strongly tacky acrylic copolymer is applied wholly or partially to one side or both sides of the sheet material and is dried. Therefore, a strongly tacky coating film can be strongly joined to the non-tacky or weakly tacky acrylic copolymer which is infiltrated into the sheet material and dried. Therefore, there is no fear of the strongly tacky coating film peeling off carelessly from the sheet material. Moreover, since a quantity of the aqueous emulsion of the strongly tacky acrylic copolymer to be applied to one side or both sides of the sheet material is adjustable freely, an adhesive sheet in which the degree of tackyness of one side or both sides can adjust easily can be manufactured easily and cheaply.

Preferably, in each of the above-mentioned methods, the sheet material consists of a cloth, paper, or sponge.

Further preferably, in each of the above-mentioned methods, dryness of sheet material is performed at a temperature not more than 160 degrees C. According to this constitution, after drying the aqueous emulsion of the non-tacky or weakly tacky acrylic copolymer or the aqueous emulsion of a strongly tacky acrylic copolymer, it can be again made aqueous emulsion by soaking it in warm water etc.. Therefore, it is possible to manufacture a resin-coated sheet which is easy to classify and discard according to material and is easy to reuse.

Further preferably, the aqueous emulsion of the non-tacky or weakly tacky acrylic copolymer contains water of not less than 60 weight %, and, on the other hand, the aqueous emulsion of the strongly tacky acrylic copolymer contains water of not less than 50 weight %. According to this constitution, since the aqueous emulsions of these acrylic copolymers can have moderate viscosity, the work for infiltrating these acrylic emulsions into the sheet materials or the work for applying them can be carried out easily.

### BRIEF EXPLANATION OF THE DRAWINGS

FIGS. 1(a), (b), and (c) are front, side, and rear views respectively showing a sheet material used in the method for manufacturing a resin-coated sheet according to the present invention.

FIGS. 2(a) and (b) are rear and cross-sectional views respectively showing a manufacturing process of a resin-coated sheet according a first embodiment of the present invention.

FIG. 3 is a view showing the next manufacturing process of the resin-coated sheet according the first embodiment of the present invention.

FIGS. 4(a) and (b) are rear and cross-sectional views respectively showing the next manufacturing process of the resin-coated sheet according the first embodiment of the present invention.

FIGS. 5(a) and (b) are front and cross-sectional views respectively showing an example of processing of the resin-coated sheet manufactured by the first embodiment of the present invention.

FIGS. 6(a) and (b) are cross-sectional and rear views respectively showing a manufacturing process of a resin-coated sheet according to a second embodiment of the present invention.

FIGS. 7(a) and (b) are front and cross-sectional views respectively showing an example of processing of the resin-coated sheet manufactured by the second embodiment of the present invention.

FIG. 8 is a cross-sectional view showing an alternative example of manufacturing process of the resin-coated sheet according to the second embodiment of the present invention.

FIGS. 9(a) and (b) are cross-sectional views respectively showing an example of processing and a manufacturing process of a resin-coated sheet according to a third embodiment of the present invention.

FIG. 10 is a cross-sectional view showing an alternative example of manufacturing process of the resin-coated sheet according to the third embodiment of the present invention.

FIGS. 11(a), (b), and (c) are cross-sectional views respectively showing an example of processing and a manufacturing process of a resin-coated sheet according to a fourth embodiment of the present invention.

FIGS. 12(a) and (b) are cross-sectional views respectively showing an example of processing and a manufacturing process of a resin-coated sheet according to a fifth embodiment of the present invention.

FIGS. 13(a), (b), (c), and (d) are cross-sectional views respectively showing an example of processing and a manufacturing process of a tacky resin-coated sheet according to a sixth embodiment of the present invention.

FIG. 14 is a cross-sectional view showing an alternative example of manufacturing process of the resin-coated sheet according to the sixth embodiment of the present invention.

### BEST MODE FOR CARRYING OUT THE INVENTION

Embodiments of the present invention are explained hereinafter in conjunction with the drawings.

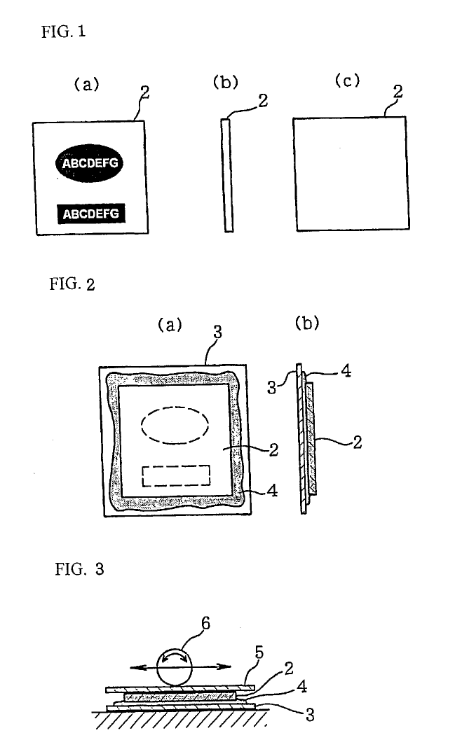

FIGS. 1 to 5 show a manufacturing process of a resin-coated sheet according to a first embodiment of the present invention. Referring to these Figures, the sheet material 2 shown in FIGS. 1(a), (b), and (c) is prepared first in this process. FIG. 1(a) shows a front side of the sheet material 2, (b) shows a side surface, and (c) shows a back side. The sheet material 2 can be made of a cloth, paper, or the like. In this case, a favorite figure, character, pattern, etc. may be printed on one side or both sides of the cloth, paper, or the like. On the other hand, an used clothing, curtain cloth and a poster, a picture postcard, a photograph, etc. can also be reused.

Next, as shown in FIGS. 2(a) and (b), an aqueous emulsion of a non-tacky or weakly tacky acrylic copolymer 4 is beforehand applied to a non-moisture-absorptive protection sheet 3 such as, for example, a cellophane film sheet, celluloid etc., and a front side (one side) of a sheet material 2 is piled up on it. Accordingly, preferably the aqueous emulsion of the non-tacky or weakly tacky acrylic copolymer 4 is infiltrated into the sheet material 2 mostly throughout the direction of thickness thereof. At this time, as shown in FIG. 3, a non-moisture-absorptive protection sheet 5 such as a cellophane film sheet, celluloid etc. is also applied to the back surface (the other side) of the sheet material 2, and when a roller 6 is pressed and rolled thereon, the non-tacky or weakly tacky acrylic copolymer 4 of a proper quantity can be uniformly and sufficiently infiltrated into the sheet material 2. Although illustration is omitted, pressure may be applied to the sheet material 2 by letting the sheet material 2 sandwiched with the protection sheets 3 and 5 pass between a pair of rollers.

In addition, the protection sheet 5 is stripped off to secure a moisture-evaporating surface, and the sheet material 2 is dried, while covering the one side of the sheet material 2 with the protection sheet 3. It is desirable to perform dryness of the sheet material 2 at the temperature of 160 degrees C or less.

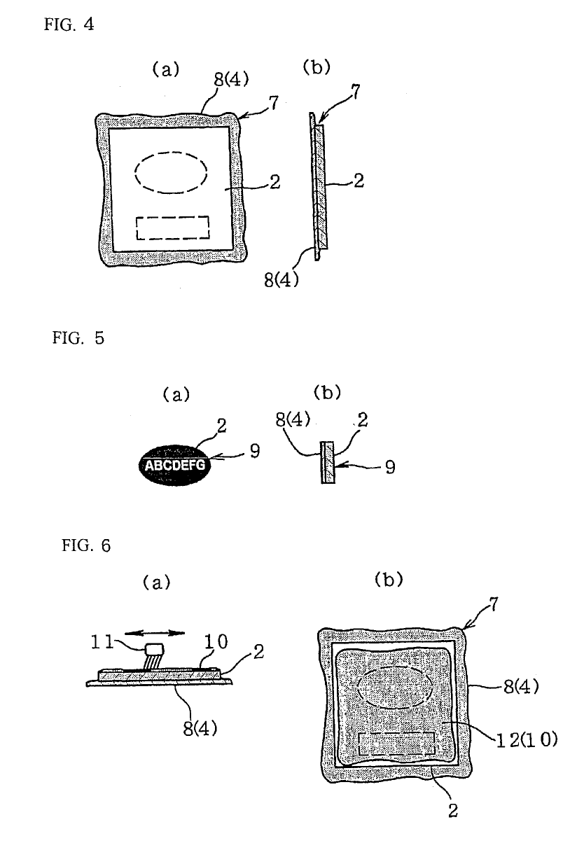

After the sheet material 2 has dried together with non-tacky or weakly tacky acrylic copolymer, as shown in FIGS. 4(a) and 4(b), the protection sheet 3 is stripped from one side of the sheet material 2, and is removed.

Then, as shown in FIGS. 5(a) and (b), a label 9, tag, decoration, etc. which covered the one side (front side) with a transparent coating film can be obtained if needed, by cutting the sheet material 2 along with the outline of a pattern for example. Moreover, since the completed resin-coated sheet 7 has an increased rigidity due to the non-tacky or weakly tacky acrylic copolymer 4 which infiltrated into the sheet material 2 and was dried, it can also be used as a sheet for crafts.

According to the above-mentioned method, it is possible to manufacture a resin-coated sheet 7 which has at one side thereof a transparent dry coating film 4 having a smooth surface which comprises an acrylic copolymer, without needing a large-scale production equipment. Further, since the transparent coating film 8 having a smooth surface is formed of the non-tacky or weak tacky acrylic copolymer 4 which has been dried after infiltrated into the sheet material 3, it is strongly joined to the sheet material 2 and there is no fear of peeling off carelessly from the sheet material 2. Moreover, although the transparent dry coating film of the acrylic copolymer 4 having a smooth surface demonstrates good waterproofness to the sheet material 2, the acrylic copolymer 4 can be easily separated from the sheet material 2 by soaking the resin-coated sheet 7 in warm water etc., and agitating it. Therefore, it is possible to manufacture a resin-coated sheet which is easy to classify and discard according to material and is easy to reuse.

Further, in the above-mentioned embodiment, since the aqueous emulsion of the non-tacky or weakly tacky acrylic copolymer 4 is beforehand applied to the protection sheet 3 and the sheet material 2 is stuck on the surface to infiltrating the aqueous emulsion of the non-tacky or weakly tacky acrylic copolymer 4 into the sheet material 2, a proper quantity of the aqueous emulsion of the non-tacky or weakly tacky acrylic copolymer 4 can be extended in the shape of a mostly uniform thick film on the protection sheet 3, and thus the aqueous emulsion of non-tacky or weakly tacky acrylic copolymer 4 can be infiltrated easily, broadly and almost uniformly to the sheet material 2. In addition, work for making a transparent coating film 8 of the acrylic copolymer with a smooth surface can be efficiently done by leaving the protection sheet 4 until the non-tacky or weakly tacky acrylic copolymer 4 dries.

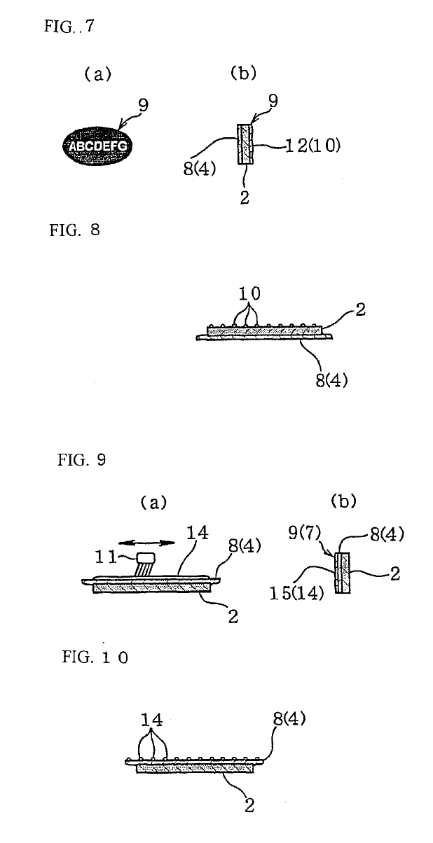

FIGS. 6(a) and (b) show a second embodiment of the present invention which is formed by adding modifications to the process of the above-mentioned first embodiment. In the processing method of the second embodiment, after the sheet material 2 into which the aqueous emulsion of a non-tacky or weakly tacky acrylic copolymer 4 has been infiltrated as described above is dried and the protection sheet 3 is stripped off, a strongly tacky coating film 12 is formed on the other side of the sheet material 2 by applying an aqueous emulsion of a strongly tacky acrylic copolymer 10 wholly or partially to the other side (back side) of the sheet material 2, by using a brush 11, spatula, etc., for example, and drying it. Then, as shown in FIGS. 7(a) and (b), a label, tag, decoration, etc. having a tacky back side can be obtained if needed, by cutting the resin-coated sheet 7 into a favorite shape. In addition, as shown in FIG. 8, the aqueous emulsion of the strongly tacky acrylic copolymer 10 may be applied with the distribution form of many points to the other side (back side) of the sheet material 2, or it may be applied thereto with the shape of many lines or lattice, or the shape of outlines of the pattern or figures.

According to this constitution, the aqueous emulsion of the strongly tacky acrylic copolymer 10 joins up strongly to the non-tacky or weak tacky acrylic copolymer 4 which has infiltrated into the sheet material 2 and has dried, and dries. Therefore, a strongly tacky coating film 12 which is made by drying the strong tacky acrylic copolymer 10 will not peel off carelessly from the sheet material 2. Accordingly, the back side of the resin-coated sheet 7 which is covered with the transparent coating film 8 of the acrylic copolymer having a smooth surface at one side can be stuck on various kinds of components via the strong tacky coating film 12, and it can be used repeatedly by separating it. Moreover, since the transparent coating film 8 in one side and the strongly tacky coating film 12 in the other side are comprised of dry acrylic copolymers 4 and 10, it is possible to easily separate these acrylic copolymers 4 and 10 from the sheet material 2 by soaking the resin-coated sheet 7 in warm water etc., and agitating it. Accordingly, it is possible to provide the resin-coated sheet 7 which has a tacky back side and which is easy to classify and discard according to material and is easy to reuse.

FIGS. 9(a) and (b) show a third embodiment of the present invention which is formed by adding other modifications to the above-mentioned first embodiment. In the third embodiment, an aqueous emulsion of a strongly tacky acrylic copolymer 4 is applied wholly or partially to the surface of the transparent coating film 8 which is formed on one side (front side) of the sheet material 2, and it is dried to form a strongly tacky coating film 15 of the dry and strongly tacky acrylic copolymer 14 on the surface of the transparent coating film 8 of the dry and non-tacky or weakly tacky acrylic copolymer 4. In addition, as shown in FIG. 10, the aqueous emulsion of the strongly tacky acrylic copolymer 14 may be applied with the distribution form of many points to the surface of the transparent coating film 8, or it may be applied thereto with the shape of many lines, lattice, or the shape of outlines of the pattern or figures.

According to this constitution, since the strongly tacky coating film 15 is formed on the transparent coating film 8 of the non-tacky or weakly tacky acrylic copolymer which has been formed on one side of the sheet material 2, the surface of the transparent coating film 8 which has been formed on one side of the sheet material 2 can adhere to a glass board, etc. via the strongly tacky coating film 15. Furthermore, since the strongly tacky coating film 15 consists of the dry strongly tacky acrylic copolymer 14, it can be transparentized by making thickness thin. Accordingly, when pattern or characters, figures, etc. is in the one side of the sheet material 2 and the surface of the transparent coating film 8 is adhered to a glass surface etc. via the strongly tacky coating film 15, the pattern, characters, figures, etc. of the sheet material 2 can be seen through the transparent glass board, the strong tacky coating film 15, and the transparent coating film 8. Therefore, the tacky resin-coated sheet 7 which is rich in ornament nature can be manufactured easily.

FIGS. 11(a), (b) and (c) show a fourth embodiment of the present invention which is formed by adding other modifications to the above-mentioned first embodiment. In the process of the fourth embodiment, after the aqueous emulsion of the non-tacky or weakly tacky acrylic copolymer 4 has been infiltrated into the sheet material 2 and the sheet material 2 is dry, the protection sheet 3 is stripped from the one side of the sheet material 2, and an aqueous emulsion of a non-tacky or weakly tacky acrylic copolymer 16 which consists of the same composition as that of the aforementioned non-tacky or weakly tacky acrylic copolymer 4 is infiltrated into the other side of the sheet material 2. Then, the sheet material 2 is dried while keeping a non-moisture-absorptive protection sheet 17 having a smooth surface in close contact with the other side of the sheet material 2. Then, a transparent coating film 18 comprised of the dried non-tacky or weakly tacky acrylic copolymer 16 and having a smooth surface is formed on the other side of the sheet material 2 by stripping off the protection sheet 17 from the other side of the sheet material 2. Then, a label 19, etc can be taken by cutting the resin-coated sheet 7 into a favorite shape.

According to this constitution, the resin-coated sheet 7 which has the transparent coating film 8 and 18 consisting of the acrylic copolymer 8 and 16 at the both sides of the sheet material 2 and is excellent in the waterproofness can be manufactured easily and cheaply.

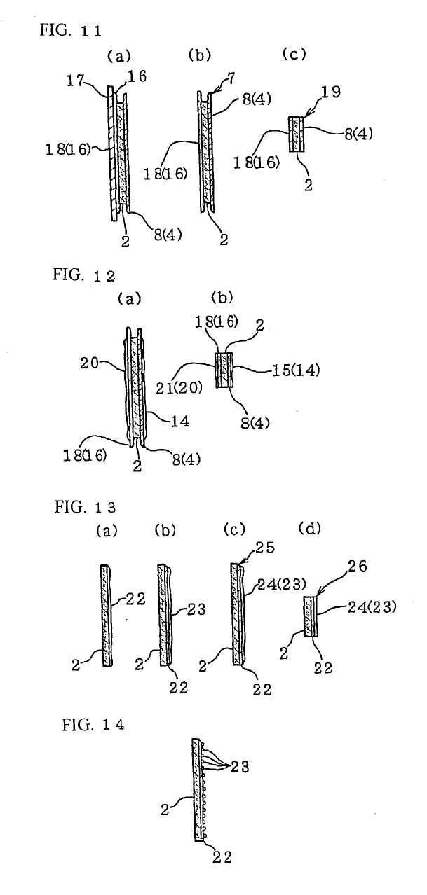

FIGS. 12(a) and (b) show a fifth embodiment of the present invention which is taken by adding other modifications to the process in the aforementioned first, third, or fourth embodiment. In the process of the fifth embodiment, the strongly tacky acrylic copolymer 14 is applied wholly or partially to the surface of the transparent coating film 8 formed in one side of the sheet material 2 and is dried, so that the strongly tacky coating film 15 is formed on the surface of the transparent coating film 8 in one side of the sheet material 2. Also the strongly tacky acrylic copolymer 20 is applied wholly or partially to the surface of the transparent coating film 18 formed in the other side of the sheet material 2 and is dried, so that the strongly tacky coating film 21 is formed on the surface of the transparent coating film 8 in the other side of the sheet material 2.

According to this constitution, the resin-coated sheet 7 which has the transparent coating films 8 and 18 which have smooth surfaces and consist of the dried non-tacky or weakly tacky acrylic copolymers 4 and 10 in the both sides of the sheet material 2 and has tackyness according to the strongly tacky coating films 15 and 21 on the surfaces of the transparent coating films 8 and 21 in both sides and which is excellent in the waterproofness can be manufactured easily and cheaply.

FIGS. 13(a), (b), (c), and (c) show a manufacturing process of the tacky resin-coated sheet according to a sixth embodiment of the present invention. In the manufacturing process of this embodiment, after an aqueous emulsion of a non-tacky or weakly tacky acrylic copolymer 22 including water as a main evaporation ingredient was infiltrated into the moisture-permeable sheet material 2 throughout almost the entire range in its thickness direction, the sheet material 2 is dried. At this time, a protection sheet such as used in the aforementioned embodiments can be omitted in this embodiment. Then, a transparent coating film 24 consisting of a dried strongly tacky acrylic copolymer 23 is formed on one side (or both sides, although illustration is omitted) of the sheet material 2, by applying an aqueous emulsion of a strongly tacky acrylic copolymer 23 to one side (or both sides, although illustration is omitted) of the sheet material 2 wholly or partially and drying it. In this way, a single-sided adhesion tape 26 (or double sided adhesion tape, although illustration is omitted) can be obtained by cutting out the created adhesive resin-coated sheet 25 into a favorite shape.

According to the above-mentioned manufacturing process, since the strongly tacky coating film 24 consisting of the dried strongly tacky acrylic copolymer 23 has tackyness when dry, one side or both sides of the resin-coated sheet 25 can adhere to the surface of the several components via the strongly tacky coating film 24, and it can peel off and be used repeatedly. Moreover, since after the non-tacky or weakly tacky acrylic copolymer 22 which was infiltrated into the sheet member 2 has been dried, the aqueous emulsion of the strongly tacky acrylic copolymer 23 is applied either wholly or partially to the one side or both sides of the sheet material 2 and is then dried, the strongly tacky coating film 24 can be strongly joined to the non-tacky or weakly tacky acrylic copolymer 22 which is infiltrated into the sheet material 2 and is dried. Accordingly, there is no fear of the strongly tacky coating film 24 separating carelessly from the sheet material 2. Moreover, since a quantity of the aqueous emulsion of the strongly tacky acrylic copolymer 23 which is to be applied to the one side or the both sides of the sheet material 2 is freely adjustable, it is possible to easily and cheaply manufacture the one-sided or double-sided adhesive sheet which can adjust easily the degree of adhesion of one side or both sides.

For example, a cloth, paper, spongy sheet, etc. can be used as the sheet material 2 in the sixth embodiment, and a used cloth, paper, spongy sheet, etc. can be recycled. Moreover, the strongly tacky acrylic copolymer 23 may be applied to the surface of the dried non-tacky or weak tacky acrylic copolymer 22, in the shape of distribution of many points or many lines, or in the shape of lattice pattern, or in the shape of an outline of a figure or pattern etc..

In the above-mentioned processes, preferably, dryness of the sheet material 2 is performed at the temperature of 160 degrees C or less. According to this constitution, after the aqueous emulsion of the non-tacky or weakly tacky acrylic copolymer 4, 16 or 22 has been dried, it can return to aqueous emulsion again by soaking the sheet material 2 in warm water etc.. Therefore, it is possible to manufacture the resin-coated sheets 7 and 25 which are easy to classify and discard according to material and is easy to reuse.

Further, in the above-mentioned embodiments, preferably, the aqueous emulsion of the non-tacky or weakly tacky acrylic copolymer 4, 16 or 22 contains acrylic copolymer includes water of not less than 60 weight % as a main evaporation ingredient. On the other hand, preferably, the aqueous emulsion of the strongly tacky acrylic copolymer 10, 14, 20 or 23 contains water of not less than 50 weight % as a main evaporation ingredient. According to this constitution, since the aqueous emulsions of these acrylic copolymers have moderate viscosity, it is possible to perform easily the work for infiltrating the aqueous emulsions consisting of these acrylic copolymers into the sheet material 2 or for applying them on the sheet.

Preferably, the aqueous emulsion of the non-tacky or weakly tacky acrylic copolymer 4 in the above-mentioned embodiments contains an ethylene-acetic acid vinyl copolymer and an acetic acid vinyl-acrylics copolymer as a solid ingredient. Moreover, the aqueous emulsion of the strongly tacky acrylic copolymer 10 contains an acetic acid vinyl-acrylics polymer as a solid ingredient preferably.

Although the present invention has been explained based on the embodiments shown in the drawings. However, the present invention is not limited only to the modes of the above-mentioned and various modifications can be added to respective constituent matters within the scope of the present invention. For example, in case the aqueous emulsion of the strongly tacky acrylic copolymer is applied, multilayer coating can be carried out making it dry for each layer.

### INDUSTRIAL APPLICABILITY

As apparent from the above explanation, according to the present invention, it is possible to provide a method for manufacturing easily and cheaply a resin-coated sheet which has a transparent resinous coating film having a smooth surface and which is easy to classify and discard according to material.

Moreover, according to the present invention, it is possible to provide a method for manufacturing easily and cheaply an adhesive resin-coated sheet which can be used many times if needed, stripping repeatedly and which is easy to classify and discard according to material.

What is claimed is:

1. A method for manufacturing a resin-coated sheet, comprising the steps of: infiltrating an aqueous emulsion of a non-tacky or weakly tacky acrylic copolymer having water as a main evaporation ingredient into a moisture-permeable sheet material throughout almost the entire range in its thickness direction; placing a non-moisture-absorptive protection sheet which has a smooth surface on and in close contact with one side of said sheet material and then drying said sheet material; and forming a transparent coating film which has a smooth surface and comprises a dried non-tacky or weakly tacky acrylic copolymer, on one side of said sheet material by stripping said protection sheet from said sheet material.

2. The method according to claim 1 further comprising the step of forming a strongly adhesive coating film on the other side of said sheet material by applying an aqueous emulsion of a strongly tacky acrylic copolymer wholly or partially to the other side of said sheet material and then drying it, after said sheet material has dried.

3. The method according to claim 1 further comprising the step of forming a strongly tacky coating film on a surface of said transparent coating film by applying an aqueous emulsion of a strongly tacky acrylic copolymer wholly or partially to the surface of said transparent coating film formed on the one side of said sheet material.

4. The method according to claim 1 or 3 further comprising the steps of: infiltrating an aqueous emulsion of a non-tacky or weakly tacky acrylic copolymer into the other side of said sheet material, after said protection sheet has been stripped from the one side of said sheet material; drying said sheet material while keeping the other side of said sheet material in close contact with a non-moisture-absorptive protection sheet having a smooth surface; and forming a transparent coating film having a smooth surface and consisting of a dry non-tacky or weakly tacky acrylic copolymer onto the other side of said sheet material, by stripping said protection sheet from the other side of said sheet material.

5. The method according to claim 4 further comprising the step of forming a strongly adhesive coating film on a surface of said transparent coating film at the other side of said sheet material by applying an aqueous emulsion of a strongly tacky acrylic copolymer wholly or partially to the surface of said transparent coating film and drying it.

6. The method according to claim 1 or 4, wherein said aqueous emulsion of the non-tacky or weakly tacky acrylic copolymer is beforehand applied to the surface of said protection sheet, and said aqueous emulsion is infiltrated into said sheet material by sticking said sheet material on the surface.

7. A method for manufacturing a resin-coated sheet, comprising the steps of: infiltrating an aqueous emulsion of a non-tacky or weakly tacky acrylic copolymer into a moisture-permeable sheet material throughout almost the entire range in its thickness direction; drying said sheet material; and forming a strongly tacky coating film on one side or both sides of said sheet material by applying an aqueous emulsion of a strongly tacky acrylic copolymer wholly or partially to one side or both sides of said sheet material and drying it.

8. The method according to any of claims 1 to 7, wherein said sheet material consists of a cloth, paper, or sponge.

9. The method according to any of claims 1 to 9, wherein dryness of sheet material is performed at a temperature of not more than 160 degrees C.

10. The method according to claim 1, 4 or 7, wherein said aqueous emulsion of the non-tacky or weakly tacky acrylic copolymer includes water of not less than 60 weight %.

11. The method according to claim 2, 3, 5 or 7, wherein said aqueous emulsion of the strongly tacky acrylic copolymer includes water of not less than 50 weight %.
